(19) United States
(12) Patent Application Publication
(10) Pub. No.: US 2012/0250181 A1
(43) Pub. Date: Oct. 4, 2012

(54) DATA STORAGE SYSTEM WITH SELF-SERVO-WRITING AND METHOD OF OPERATION THEREOF

(75) Inventors: Zhi Wang, San Jose, CA (US); Tung H. Nguyen, San Jose, CA (US); Glenn G. Kim, Santa Clara, CA (US)

(73) Assignee: SAMSUNG ELECTRONICS CO., LTD., Gyeonggi-Do (KR)

(21) Appl. No.: 13/075,132

(22) Filed: Mar. 29, 2011

(51) Int. Cl. G11B 5/596

(52) U.S. Cl. 360/77.04; G9B/5.216

(57) ABSTRACT

A method of operation of a data storage system includes: providing a disk having a reference servo; and positioning a read/write head over the disk with the reference servo including: collecting a raw phase error, estimating a phase delay error, estimating an estimated written-in error with the phase delay error subtracted from the raw phase error, calculating a remaining error based on the estimated written-in error, and adjusting a self-servo-writing clock based on the remaining error.

### TECHNICAL FIELD

The present invention relates generally to a data storage system, and more particularly to a system for a data storage system with servo.

### BACKGROUND ART

Disk drives are used for data storage in modern electronic products ranging from digital cameras to computer systems and networks. Typically, a disk drive includes a mechanical portion, or head disk assembly (HDA), and electronics in the form of a printed circuit board assembly (PCB), mounted to an outer surface of the HDA. The PCB controls HDA functions and provides an interface between the disk drive and its host.

Generally, a HDA comprises one or more magnetic disks affixed to a spindle motor assembly for rotation at a constant speed, an actuator assembly supporting an array of read/write heads that traverse generally concentric data tracks radially spaced across the disk surfaces and a voice coil motor (VCM) providing rotational motion to the actuator assembly. Modem disk drives typically utilize magneto resistive head technology that employs both an inductive element, for writing data to the data tracks and a magneto resistive element for reading data from the recording tracks.

Continued demand for disk drives with ever increasing levels of data storage capacity, faster data throughput, and decreasing price per megabyte have led disk drive manufacturers to seek ways to increase the storage capacity and improve overall operating efficiencies of the disk drive. Present generation disk drives typically achieve aerial bit densities of several gigabits per square centimeter, Gbits/cm². Increasing recording densities can be achieved by increasing the number of bits stored along each track or bits per inch (BPI), generally requiring improvements in the read/write channel electronics, and/or by increasing the number of tracks per unit width or tracks per inch (TPI), generally requiring improvements in servo control systems.

Servo fields written to the surface of the disk provide positional information used by the servo control system to control position of the read/write heads relative to the rotating magnetic disk. As TPI escalate, servo field writing techniques that incorporate servo track writers are unable to provide servo fields with sufficient accuracy to support the increased track densities.

Thus, a need still remains for a data storage system with self-servo-writing mechanism for increasing levels of functionality. In view of ease of use, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a data storage system including: providing a disk having a reference servo; and positioning a read/write head over the disk with the reference servo including: collecting a raw phase error, estimating a phase delay error, estimating an estimated written-in error with the phase delay error subtracted from the raw phase error, calculating a remaining error based on the estimated written-in error, and adjusting a self-servo-writing clock based on the remaining error.

The present invention provides a data storage system, including: a disk having a reference servo; a read/write head coupled to and positioned over the disk with the reference servo; a collect error module, coupled to the read/write head, for collecting a raw phase error; a phase delay detection module, coupled to the collect error module, for estimating a phase delay error; a phase anticipation detection module, coupled to the phase delay detection module, for estimating an estimated written-in error with the phase delay error subtracted from the raw phase error; an error subtraction unit, coupled to the phase anticipation detection module, for calculating a remaining error based on the estimated written-in error; and a voltage controlled oscillator, coupled to the error subtraction unit, for adjusting a self-servo-writing clock based on the remaining error.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a schematic diagram of a data storage system with self-servo-writing mechanism in an embodiment of the present invention.

FIG. 2 is a block diagram of the data storage system.

FIG. 3 is a flow control diagram of the data storage system.

FIG. 4 is a graph of phase error decomposition.

FIG. 5 is a graph of final phase error comparison.

FIG. 6 is a flow chart of a method of operation of the data storage system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Self-servo-writing (SSW) in hard disk drive (HDD) industry is a method for writing servo patterns. With self-servo-writing (SSW), higher throughput of the servo-writing process can be maintained without increasing the production cost and process time since it can be performed in an area outside of an expensive clean room and can be implemented as part of the manufacturing verification process.

In the area of SSW, one of the most unique and innovative advances in hard disk drive design is a new manufacturing technology for seed servo-writing called no-clock-head (NCH) servo-writers. The no-clock-head servo is written by the disk drive without using a separate servo writer. No-clock-head servo writing is performed by the disk drive itself and is enabled by the addition of circuitry that performs a real-time servo control of the spindle motor to maintain constant speed.

NCH servo-writers are keys to a non-invasive servo-writing process that removes the clock heads used in traditional servo-writing. As a result, performance, reliability, and quality are much higher for hard disk drives manufactured with this new process.

However, a problem exists when the initial timing phase error is generally much larger than the one traditionally written with clock head. For example, NCH drives could observe 20-30 times larger phase error than that in clock head drives in a written-in phase error comparison. A larger phase error can be caused by drift in the spindle motor speed, when the servo is written.

If such a large initial phase error enters into the control system, it will cause a problem of the instability of the channel PLL frequency adjustment loop because the VCO compensation capability is very limited. A pre-calibration/control can handle those bigger-than-expected phase errors. Embodiments of the present invention provide answer or solution to the problems.

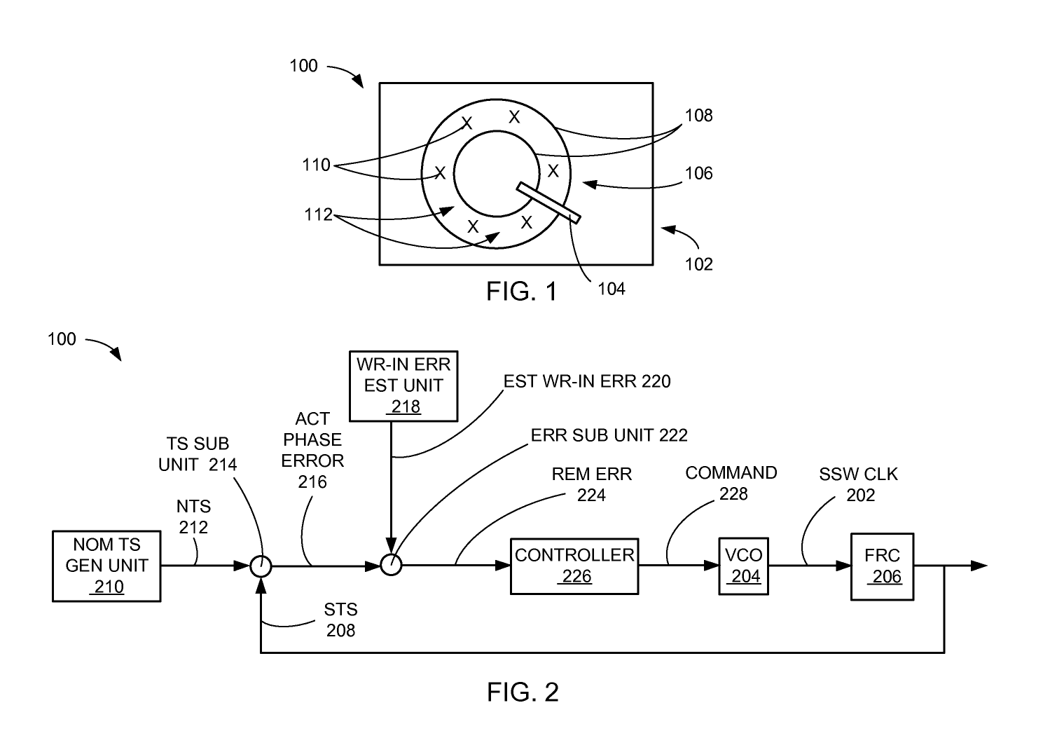

Referring now to FIG. 1, therein is shown a schematic diagram of a data storage system 100 with self-servo-writing mechanism in an embodiment of the present invention. The data storage system 100 can include a disk drive 102, which is a non-volatile storage device. The disk drive 102 can include a hard disk assembly (HDA) and a printed circuit board (PCB) with a storage buffer and a processor for performing processing that is related to the operation of the disk drive 102.

The disk drive 102 can include a read/write head 104, which is a device in the HDA for reading from and writing data to a storage medium. The read/write head 104 can be located near a distal end of an actuator arm (not shown). The read/write head 104 can include a write element including an inductor (not shown) that generates a magnetic field.

The read/write head 104 can also include a read element including a magneto-resistive (MR) element that senses magnetic field on a disk 106, which is a component of the disk drive 102 on which magnetic data is stored. For example, the read element can include magneto-resistive (MR) element, metal in gap (MIG), anisotropic magneto-resistive (AMR) element, tunneling magneto-resistive (TMR), perpendicular magnetic recording (PMR), or a magnetizable material.

The disk 106 can represent a hard disk platter that is mounted on a spindle. The disk 106 can be written or read on one or both sides of the disk 106 by the read/write head 104. The disk 106 can include data tracks 108, shown in concentric circles as examples, for data to be written to or read from. The data tracks 108 can be divided radially into a number of reference servos 110 and data sectors 112.

The read/write head 104 can move above the disk 106. The read/write head 104 can transform a magnetic field into an electrical current when reading the disk. The read/write head 104 can transform an electrical current into a magnetic field when writing the disk 106. The read/write head 104 can access the contents of the disk 106 including the reference servos 110, the data sectors 112, or a combination thereof.

The reference servos 110 provide positioning information for the read/write head 104 to lock onto the data tracks 108 before performing a read/write operation at correct locations on the data sectors 112. The reference servos 110 are shown with ‘x’ marks in the schematic diagram, as an example. The reference servos 110 can be written in wedges or spiral patterns on the disk 106. Each of the reference servos 110 can be written between the data sectors 112 that are adjacent to each other.

The data sectors 112 are portions on the data tracks 108 that contain data or information that is written by the read/write head 104. Circumferential lengths of the data sectors 112 decrease as diameters of the data tracks 108 decrease towards the center of the disk 106.

The read/write head 104 can be flown over the disk 106. The term “flown” or “flying the read/write head” means that the read/write head 104 is positioned over the disk 106 before performing a read or write operation. The read/write head 104 can be positioned using or with the reference servos 110 for locating the data sectors 112. Data can be reliably accessed in read and write operations using a timing/phase error compensation.

Referring now to FIG. 2, therein is shown a block diagram of the data storage system 100. The data storage system 100 can include a self-servo-writing (SSW) system. The data storage system 100 can include the timing/phase error decomposition to compensate or handle a large initial timing error on no-clock-head (NCH) drives.

When the data storage system 100 writes the reference servos 110 of FIG. 1 using the self-servo-writing (SSW) methods, the read/write head 104 of FIG. 1 typically lock onto seed servo sectors depicted as the reference servos 110, which are prewritten on the platters either concentrically or in the form of spirals. Then, the data storage system 100 can write a final servo pattern using a self-servo-writing clock 202 (SSW clock). The block diagram depicts the data storage system 100 having a phase-locked loop (PLL) that can be used to synchronize the self-servo-writing clock 202 to the seed servo sectors.

The self-servo-writing clock 202 is a clock that is adjusted to be phase aligned with a reference clock. The self-servo-writing clock 202 can include a frequency that matches a frequency of the reference clock. For example, the self-servo-writing clock 202 can represent a clock for self-servo-writing in a system-on-chip (SOC). The self-servo-writing clock 202 can be phase-locked to the seed servo sectors in order to correctly write the final servo pattern.

The phase-locked loop (PLL) can include a voltage controlled oscillator 204 (VCO) to adjust the frequency and thus the phase of the self-servo-writing clock 202. Once the self-servo-writing clock 202 is phase-locked to the seed servo sectors, the final burst patterns can then be written using the self-servo-writing clock 202 at uniform spacing between the seed servo sectors. The self-servo-writing clock 202 can be used to measure the time between two consecutive sync marks of the seed servo sectors.

The data storage system 100 can include a free-running counter 206, which is a module that counts, detects, and reports when a count value is compared to and reaches a pre-determined end value. The pre-determined end value is determined based on a number of clock cycles of the self-servo-writing clock 202 that are calculated or expected to occur between servo sync marks that are indicated by the reference servos 110. The free-running counter 206 can be coupled to the voltage controlled oscillator 204.

The free-running counter 206 can be used to detect a phase error by performing a counter comparison by matching the count value compared with the actual arrival of the servo sync mark. Each time the free-running counter 206 reaches or matches the pre-determined end value for the counter comparison, a servo sync mark should be detected. The phase error is determined by which event happens first and by how much the time difference is. The event is an occurrence including the counter comparison or the servo sync mark.

The free-running counter 206 can be clocked by the self-servo-writing clock 202. A counting system, depicted as the free-running counter 206, can generate a self-servo-writing timestamp 208 (STS) with the self-servo-writing clock 202. The self-servo-writing timestamp 208 (STS) can be generated or updated every time a synch mark is detected from the seed servo sectors.

The data storage system 100 can include a nominal timestamp generation unit 210 to generate a nominal timestamp 212 (NTS). The nominal timestamp generation unit 210 can generate the nominal timestamp 212 based on the nominal calculation. The nominal timestamp 212 occurs or is active when a sync mark is expected to occur at a seed servo sector.

The data storage system 100 can include a timestamp subtraction unit 214 to calculate an actual phase error 216. The timestamp subtraction unit 214 can be coupled to the free-running counter 206 and the nominal timestamp generation unit 210. The actual phase error 216 is calculated as a difference between a measured timestamp value, depicted as the self-servo-writing timestamp 208 (STS), and a calculated timestamp value, depicted as the nominal timestamp 212 (NTS).

The actual phase error 216 can be generated based on the self-servo-writing timestamp 208 (STS) and the nominal timestamp 212 (NTS). The self-servo-writing timestamp 208 (STS) can be generated by the free-running counter 206 operated based on the self-servo-writing clock 202.

The data storage system 100 can include the PLL to minimize the actual phase error 216 by adjusting the frequency of the self-servo-writing clock 202 using the voltage controlled oscillator 204. The frequency of the self-servo-writing clock 202 can be adjusted by matching the self-servo-writing timestamp 208 (STS) with the nominal timestamp 212 (NTS).

The data storage system 100 can include a written-in error estimation unit 218 to estimate and generate an estimated written-in error 220. The estimated written-in error 220 is an estimated value of a phase error due to written-in variations caused by seed servo-writing.

The data storage system 100 can include an error subtraction unit 222 to detect or calculate a remaining error 224. The error subtraction unit 222 can be coupled to the timestamp subtraction unit 214 and the written-in error estimation unit 218.

The remaining error 224 is calculated by subtracting the estimated written-in error 220 from the actual phase error 216. For example, the error subtraction unit 222 can represent a phase comparator or a phase detector.

The data storage system 100 can include a controller 226 to generate a command 228. The controller 226 can be coupled to the error subtraction unit 222 and the voltage controlled oscillator 204.

For illustrative purposes, the timestamp subtraction unit 214 and the error subtraction unit 222 are shown as separate units from the controller 226, although it is understood that the timestamp subtraction unit 214, the error subtraction unit 222, and the controller 226 can include a different partition. For example, the controller 226 can include a loop filter including the timestamp subtraction unit 214, the error subtraction unit 222, or a combination thereof.

The command 228 is used to control the operation of the voltage controlled oscillator 204. The command 228 functions as a command sent to the voltage controlled oscillator 204 for offset compensation or enable.

The command 228 can be generated based on the remaining error 224. The command 228 can indicate how much the voltage controlled oscillator 204 can adjust the self-servo-writing clock 202 so that the self-servo-writing clock 202 can be used to generate the self-servo-writing timestamp 208 to be in-phase with the nominal timestamp 212.

The controller 226 can detect and process the actual phase error 216. The controller 226 can include a low pass filter to remove any high frequency elements on the remaining error 224 to generate the command 228. The command 228 can be applied as a tuning voltage to a control terminal of the voltage controlled oscillator 204.

The voltage controlled oscillator 204 can sense any change in the state of the command 228. For example, the voltage controlled oscillator 204 can sense any change in the tuning voltage. The voltage controlled oscillator 204 can adjust the self-servo-writing clock 202 so that phase difference and thus frequency difference can be reduced between the self-servo-writing timestamp 208 (STS) with the nominal timestamp 212 (NTS).

Initially, the PLL loop can be out of lock due to the remaining error 224 and change in the tuning voltage being high. The voltage controlled oscillator 204 can adjust the frequency of the self-servo-writing clock 202 so that the self-servo-writing timestamp 208 (STS) can be in-phase with the nominal timestamp 212 (NTS). When the remaining error 224 cannot be reduced further, the PLL loop can be in lock.

When the PLL is in lock, the command 228 can be in a steady state such that there is no change in the tuning voltage input to the voltage controlled oscillator 204. The command 228 in a steady state means that the phase difference between the self-servo-writing timestamp 208 (STS) and the nominal timestamp 212 (NTS) is not changing. As a result, the self-servo-writing timestamp 208 (STS) and the nominal timestamp 212 (NTS) can include the same frequency.

It has been discovered that the remaining error 224 calculated based on the estimated written-in error 220 provides improved data integrity with a robust timing/phase error decomposition approach that resolves the initial huge timing error thereby avoiding the instability issue for no-clock-head (NCH) drives.

Further to the discovery, the remaining error 224 provides opportunities for significant cost reduction and non-invasive servo write solution as well as enables introduction of no-clock-head (NCH) writing technology for seed servo pattern generation with no extra cost introduced.

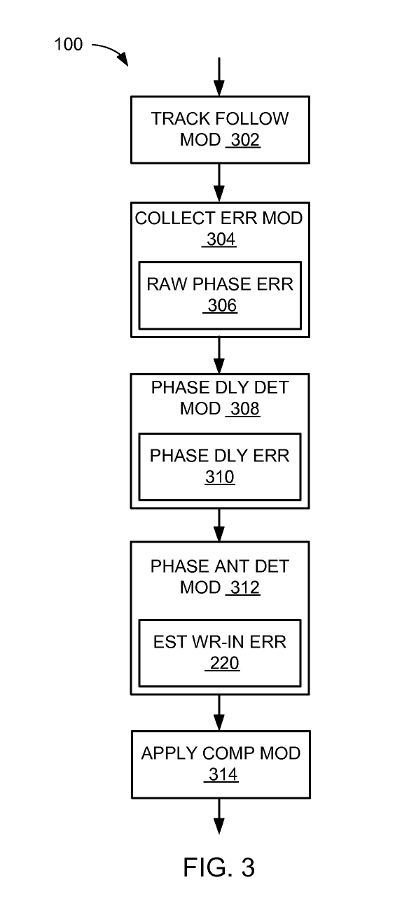

Referring now to FIG. 3, therein is shown a flow control diagram of the data storage system 100. The flow control diagram depicts a flow chart or a procedure of an initial phase error decomposition. The read/write head 104 of FIG. 1 can be positioned over the disk 106 of FIG. 1 with the reference servos 110 of FIG. 1 using the flow control diagram.

The data storage system 100 can include a track follow module 302 to perform a track-following function. Once the read/write head 104 reaches the target track with track-seeking mechanism, the track follow module 302 can regulate or control the read/write head 104 over the track so that the read/write head 104 can follow the track during the operation of reading or writing data with a track-following control mechanism.

The data storage system 100 can include a collect error module 304 to collect a raw phase error 306. The track follow module 302 can notify or signal the collect error module 304 to proceed with the error collection process. The collect error module 304 can be coupled to the track follow module 302 and the read/write head 104.

The raw phase error 306 can be collected or measured for one revolution of the spindle of the hard disk drive. The raw phase error 306 can be collected or sampled with a raw STS phase error measurement of the self-servo-writing timestamp 208 (STS) of FIG. 2.

The data storage system 100 can include a phase delay detection module 308 to estimate a phase delay error 310. The phase delay detection module 308 can be coupled to the collect error module 304.

The phase delay error 310 is a portion of a timing error that changes from time to time but much slower compared to changes of other portions of the timing error. For example, the phase delay error 310 can represent a slow time varying error contributed by spindle speed variations from the nominal constant speed.

The phase delay error 310 can be estimated using a statistical approach including linear regression, cross-sectional regression, curve fitting, nonlinear regression, nonparametric regression, Bayesian methods, least absolute deviations, or any other regression analysis. In other words, the phase delay error 310 can be estimated by determining or finding a line that best fits between a dependent variable and a number of independent variables. The phase delay error 310 can be estimated with a linear function having minimum errors between estimated and actual data.

The phase delay error 310 can be estimated using a linear regression model that can be fitted using the least squares approach. The least squares approach means that the overall solution minimizes the sum of the squares of the residuals or the errors made in solving every single equation.

The phase delay error 310 can also be estimated by minimizing the lack of fit using a minimization process including least absolute deviations (LAD) regression. The phase delay error 310 can further be estimated by minimizing a penalized version of the least squares loss function including ridge regression.

The least absolute deviations (LAD) regression is an optimization technique similar to the least squares approach and attempts to find a function, which closely approximates a set of data. The method can minimize the sum of absolute errors (SAE) or the sum of the absolute values of the vertical “residuals” between points generated by the function and corresponding points in the data. The least absolute deviations (LAD) regression can include least absolute errors (LAE) or least absolute value (LAV).

A loss function is a function that maps an event onto a real number representing the economic cost or regret associated with the event. More specifically, in statistics a loss function represents the loss associated with an estimate being “wrong”, which is different from either a desired or a true value. The loss is a function of a measure of the degree of wrongness and is expressed as a difference between the estimated value and the true or desired value.

The data storage system 100 can include a phase anticipation detection module 312 to estimate the estimated written-in error 220. The phase anticipation detection module 312 can be coupled to the phase delay detection module 308.

The estimated written-in error 220 is another portion of the timing error that occurs in the written-in by seed servo pattern generation. The estimated written-in error 220 can represent a written-in phase error that is repeatable. In other words, the estimated written-in error 220 can be fixed from revolution to revolution on the same track and same wedge. A wedge, depicted as one of the reference servos 110, is a gap or portion between the data sectors 112 of FIG. 1 in the data tracks 108 of FIG. 1 of the disk 106. The wedge can include feedback information for a voice coil motor or actuator of the read/write head 104 to position above the disk 106. The estimated written-in error 220 can be estimated by subtracting the phase delay error 310 from the raw phase error 306.

The phase anticipation detection module 312 can be implemented with the written-in error estimation unit 218 of FIG. 2. The phase anticipation detection module 312 can be coupled to the error subtraction unit 222 of FIG. 2.

The data storage system 100 can include an apply compensation module 314 to apply both feed-forward and feedback compensation. The apply compensation module 314 can be coupled to the phase anticipation detection module 312.

The apply compensation module 314 can interface with the free-running counter 206 of FIG. 2 to apply or send the self-servo-writing timestamp 208 (STS) to the timestamp subtraction unit 114 in the feedback path. A slow time varying error, depicted as the remaining error 224 of FIG. 2, can be compensated by feedback.

The apply compensation module 314 can interface with the phase anticipation detection module 312 to apply or send the estimated written-in error 220 to the error subtraction unit 222 in the feed-forward path. A written-in error, depicted as the estimated written-in error 220, can be cancelled by feed-forward.

Each portion of the timing error requires different treatment from control perspective. The first portion, depicted as the estimated written-in error 220, can be written-in and therefore can be filtered out using feed-forward compensation. When the estimated written-in error 220 is filtered out in the feed-forward path, an actual error can enter the phase feedback control system, such as the PLL loop, to adjust the self-servo-writing clock 202 (SSW clock) of FIG. 2. The error in the second portion, depicted as the phase delay error 310, can require feedback compensation to guarantee the uniform of the final pattern.

Through the proposed method in the flow control diagram, the initial timing error can be decomposed into the fast time varying portion, which is due to a written-in variation caused by seed servo-writing, and the slow timing-varying portion, which is related to spindle speed variation. The fast time varying portion and the slow timing-varying portion can be represented by the estimated written-in error 220 and the phase delay error 310, respectively. After the error subtraction unit 222 subtracts the written-in portion, depicted as the estimated written-in error 220, from the raw measurement, depicted as the actual phase error 216 of FIG. 2, the left over error, depicted as the remaining error 224, can enter into the phase feedback control system of the PLL loop. The left over error can represent the actual error that is due to slow time-varying.

It has been discovered that the phase delay error 310 generated by the phase delay detection module 308 as a key step of data processing in the flow control diagram provides improved reliability because the phase delay error 310 allows the actual error entering into the phase feedback control system provides correction or adjustment of the self-servo-writing clock 202 and thus the instability issue is avoided for no-clock-head (NCH) drives.

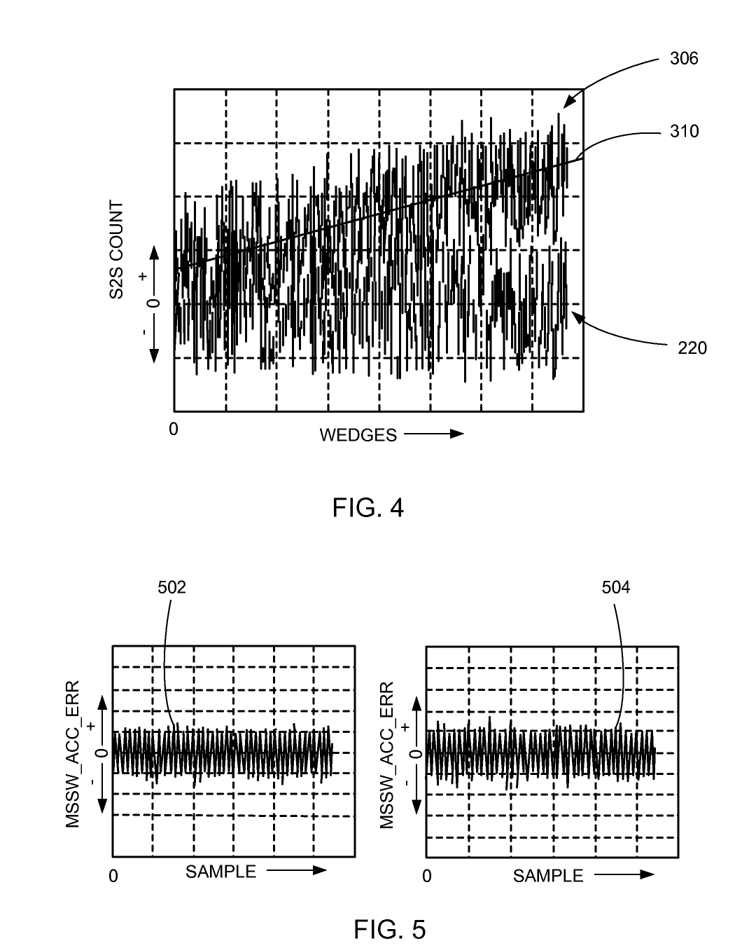

Referring now to FIG. 4, therein is shown a graph of phase error decomposition. The graph depicts the raw phase error 306. A baseline, depicted as the phase delay error 310 shown as a straight line, can be calculated by linear regression, as an example described above. The phase anticipation detection module 312 of FIG. 3 can estimate the estimated initial written-in phase error, depicted as the estimated written-in error 220, by subtracting the phase delay error 310 from the raw phase error 306.

The phase delay error 310 can be estimated by determining a line that best fits the actual values in a servo-to-servo (S2S) count in the Y-axis at a servo wedge number in the X-axis for the raw phase error 306. The servo-to-servo (S2S) count indicates servo-to-servo timing information. The servo-to-servo (S2S) count includes a number of clock cycles of the self-servo-writing clock 202 of FIG. 2 that should have occurred or already occurred when the servo sync mark is detected to indicate that the self-servo-writing clock 202 is slower or faster, respectively, than expected. The servo wedge number is a count or value of a servo wedge that is evenly spaced with an adjacent servo wedge. There can be the same number of clock cycles of the self-servo-writing clock 202 between adjacent servo wedges.

Referring now to FIG. 5, therein is shown a graph of final phase error comparison. The graph depicts a no-clock-head error profile 502, shown on the left, and a clock-head error profile 504, shown on the right.

The no-clock-head error profile 502 can include an error amplitude approximately equal to an error amplitude of the clock-head error profile 504. The no-clock-head error profile 502 and the clock-head error profile 504 are error profiles of a measurement using a no-clock-head drive and a clock head drive, respectively. The no-clock-head error profile 502 can be produced by timing/phase error decomposition using at least the phase delay error 310 of FIG. 3, the raw phase error 306 of FIG. 3, and the estimated written-in error 220 of FIG. 2.

The graph depicts a final phase error, depicted as MSSW_ACC_ERR, in each of the no-clock-head error profile 502 and the clock-head error profile 504. The final phase error is a count recorded by a variable or a register stored in a memory device used during self-servo writing. The final phase error is an accumulation error resulting from a given frequency with respect to time. The final phase error can represent a final timing error, depicted as the remaining error 224 in FIG. 2. The final phase error is an error after being compensated with the estimated written-in error 220 by subtracting the estimated written-in error 220 from the actual phase error 216 of FIG. 2.

The final phase error can include a positive sign or a negative sign. The final phase error can be based on a relationship between rates or frequencies at which the self-servo-writing timestamp 208 of FIG. 2 and the nominal timestamp 212 of FIG. 2 are generated.

For example, if the self-servo-writing clock 202 of FIG. 2 is slower than a nominal operating clock, the free-running counter 206 (FRC) of FIG. 2 can generate less counts for the self-servo-writing timestamp 208 (STS) given one wedge time. The final phase error can be positive if the final phase error is defined as a subtraction of the nominal timestamp 212 by the self-servo-writing timestamp 208.

The nominal operating clock is a clock with which the nominal timestamp 212 is generated. The wedge time is duration between two consecutive wedges, depicted as the reference servos 110 of FIG. 1.

Also for example, if the self-servo-writing clock 202 is faster than the nominal operating clock, the free-running counter 206 can generate more counts for the self-servo-writing timestamp 208 in one wedge time. The final phase error can be negative when subtracting the nominal timestamp 212 by the self-servo-writing timestamp 208.

It is discovered that the no-clock-head error profile 502 having an error amplitude approximately equal to an error amplitude of the clock-head error profile 504 indicates a significant reliability improvement because the final spiral sync timing error of no-clock-head drives is comparable to that of clock head drives resulting in no significant difference in terms of final phase error.

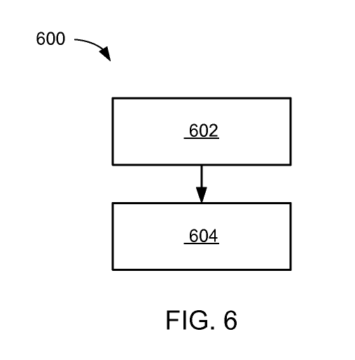

Referring now to FIG. 6, therein is shown a flow chart of a method 600 of operation of the data storage system 100 in a further embodiment of the present invention. The method 600 includes: providing a disk having a reference servo in a block 602; and positioning a read/write head over the disk with the reference servo including: collecting a raw phase error, estimating a phase delay error, estimating an estimated written-in error with the phase delay error subtracted from the raw phase error, calculating a remaining error based on the estimated written-in error, and adjusting a self-servo-writing clock based on the remaining error in a block 604.

Thus, it has been discovered that the data storage system of the present invention furnishes important and heretofore unknown and unavailable solutions, capabilities, and functional aspects for a data storage system with self-servo-writing. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a data storage system comprising:
providing a disk having a reference servo; and
positioning a read/write head over the disk with the reference servo including:
collecting a raw phase error,
estimating a phase delay error,
estimating an estimated written-in error with the phase delay error subtracted from the raw phase error,
calculating a remaining error based on the estimated written-in error, and
adjusting a self-servo-writing clock based on the remaining error.

2. The method as claimed in claim 1 wherein estimating the phase delay error includes estimating the phase delay error using statistical approach.

3. The method as claimed in claim 1 further comprising:
calculating an actual phase error based on the self-servo-writing clock; and
wherein:
calculating the remaining error includes calculating the remaining error with the estimated written-in error subtracted from the actual phase error.

4. The method as claimed in claim 1 further comprising generating a self-servo-writing timestamp with the self-servo-writing clock.

5. The method as claimed in claim 1 further comprising generating a command based on the remaining error.

6. A method of operation of a data storage system comprising:
providing a disk having a reference servo; and
positioning a read/write head over the disk with the reference servo including:
generating a nominal timestamp,
collecting a raw phase error,
estimating a phase delay error,
estimating an estimated written-in error with the phase delay error subtracted from the raw phase error,
calculating a remaining error based on the estimated written-in error, and
adjusting a self-servo-writing clock based on the remaining error.

7. The method as claimed in claim 6 wherein estimating the phase delay error includes estimating the phase delay error using linear regression.

8. The method as claimed in claim 6 further comprising:
calculating an actual phase error based on the self-servo-writing clock and the nominal timestamp; and
wherein:
calculating the remaining error includes calculating the remaining error with the estimated written-in error subtracted from the actual phase error.

9. The method as claimed in claim 6 further comprising:
generating a self-servo-writing timestamp with the self-servo-writing clock; and
calculating an actual phase error as a difference between the self-servo-writing timestamp and the nominal timestamp.

10. The method as claimed in claim 6 further comprising:
generating a command based on the remaining error; and
wherein:
adjusting the self-servo-writing clock includes adjusting the self-servo-writing clock based on the command.

11. A data storage system comprising:
a disk having a reference servo;
a read/write head coupled to and positioned over the disk with the reference servo;
a collect error module, coupled to the read/write head, for collecting a raw phase error;
a phase delay detection module, coupled to the collect error module, for estimating a phase delay error;
a phase anticipation detection module, coupled to the phase delay detection module, for estimating an estimated written-in error with the phase delay error subtracted from the raw phase error;
an error subtraction unit, coupled to the phase anticipation detection module, for calculating a remaining error based on the estimated written-in error; and
a voltage controlled oscillator, coupled to the error subtraction unit, for adjusting a self-servo-writing clock based on the remaining error.

12. The system as claimed in claim 11 wherein the phase delay detection module is for estimating the phase delay error using statistical approach.

13. The system as claimed in claim 11 further comprising:
a timestamp subtraction unit, coupled to the voltage controlled oscillator, for calculating an actual phase error based on the self-servo-writing clock; and
wherein:
the error subtraction unit is for calculating the remaining error with the estimated written-in error subtracted from the actual phase error.

14. The system as claimed in claim 11 further comprising a free-running counter, coupled to the voltage controlled oscillator, for generating a self-servo-writing timestamp with the self-servo-writing clock.

15. The system as claimed in claim 11 further comprising a controller, coupled to the error subtraction unit, for generating a command based on the remaining error.

16. The system as claimed in claim 11 further comprising a nominal timestamp generation unit for generating a nominal timestamp.

17. The system as claimed in claim 16 wherein the phase delay detection module is for estimating the phase delay error using linear regression.

18. The system as claimed in claim 16 further comprising:
a timestamp subtraction unit, coupled to the nominal timestamp generation unit, for calculating an actual phase error based on the self-servo-writing clock and the nominal timestamp; and
wherein:
the error subtraction unit is for calculating the remaining error with the estimated written-in error subtracted from the actual phase error.

19. The system as claimed in claim 16 further comprising:
a free-running counter, coupled to the voltage controlled oscillator, for generating a self-servo-writing timestamp with the self-servo-writing clock; and
a timestamp subtraction unit, coupled to the free-running counter, for calculating an actual phase error as a difference between the self-servo-writing timestamp and the nominal timestamp.

20. The system as claimed in claim 16 further comprising:
a controller, coupled to the error subtraction unit, for generating a command based on the remaining error; and
wherein:
the voltage controlled oscillator is for adjusting the self-servo-writing clock based on the command.
